(19) United States
(12) Patent Application Publication
(10) Pub. No.: US 2002/0026442 A1
(43) Pub. Date: Feb. 28, 2002

(54) System and method for the distribution and sharing of media assets between media players devices

(76) Inventors: Kenneth O. Lipscomb, Marietta, GA (US); John B. Petritis, Lawrenceville, GA (US); Richard D. Robison, Decatur, GA (US); Kelly P. Morrison, Atlanta, GA (US); Michael D. Hirsch, Atlanta, GA (US); Eric Neal Muntz, Marietta, GA (US)

Correspondence Address: D. Andrew Floam, NEEDLE & ROSENBERG, P.C., The Candler Building, Suite 1200, 127 Peachtree Street, N.E., Atlanta, GA, 30303-1811, US

(21) Appl. No.: 09/768,933

(22) Filed: Jan. 24, 2001

Related U.S. Application Data
(60) Provisional application No. 60/177,701, filed on Jan. 24, 2000.

(51) Int. Cl. G06F 17/30

(52) U.S. Cl. 707/10; 707/200

(57) ABSTRACT

A system for the distribution of media assets wherein first and second media player devices individually communicate with the server computer to update a database with the identity of the media assets that are stored thereon. The server computer transmits to each of the first and second media player devices information about the media assets that is stored on the first and second media player devices. As a result of this information, a first media player device may have knowledge of and request a media asset stored on a second media player device. The second media player device responds to the request by transferring or streaming the asset to the first media player.

This application claims priority to U.S. Provisional Application No. 60/177,701 filed Jan. 24, 2000, entitled “DISTRIBUTION/SHARING OF MEDIA ASSETS WITH MEDIA PLAYERS WITHOUT DOWNLOAD FROM CENTRAL PORTAL” the entirety of which is incorporated herein by reference.

### BACKGROUND OF THE INVENTION

Due to the increasing proliferation of digital music playback devices, a user may possess multiple media asset playback devices, such as one for the home, the car and a portable unit. Accordingly, different media assets may be stored on the different playback devices that are under the user's control. A system and method are needed which would allow the user to have access to any media asset stored on any of her/his media player devices. It is desirable to be able to coordinate the knowledge of all of the media assets stored among a user's media player devices to enable direct access to those media assets from any device.

### SUMMARY OF THE INVENTION

The present invention is directed to a system and method for the distribution and sharing of media assets. At least one server computer is provided that manages access to a library database of media assets. These media assets may be stored and accessed by users via a media player device. Each of a plurality of media player devices is in communication with the server computer. The media player devices communicate with the server computer in order to update the database with information pertaining to the media assets that are stored within each media player device.

The server computer of the system synchronizes and compiles reference data for the media assets stored on each media player device. For a designated group of media player devices the server computer shares media asset reference data pertaining to all of the media assets residing on media player devices in the group. Equipped with the reference data of all media assets that reside on the media player devices that are in that group, each media player device in the group may request or transfer media assets directly between one another without the need to go through the central computer for access to the media asset.

### BRIEF DESCRIPTION OF THE DRAWINGS

FIG. 1 is a block diagram of a system according to the invention.

FIG. 2 is a block diagram of a media player device useful in connection with the present invention.

FIG. 3 is a flow diagram representation of a process according to the present invention.

### DETAILED DESCRIPTION OF THE INVENTION

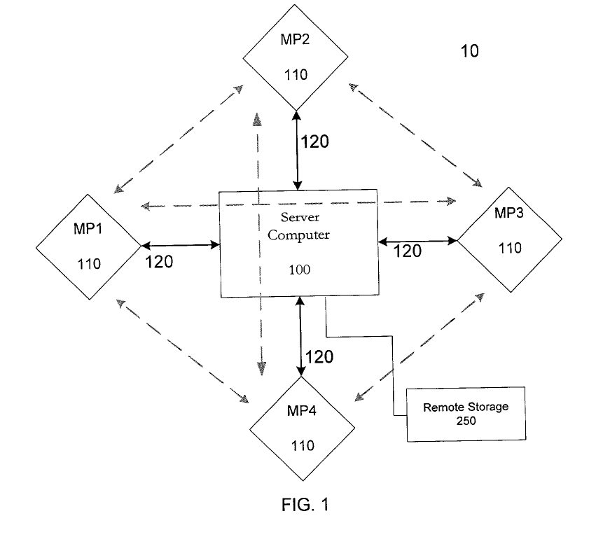

The present invention is initially described with reference to FIG. 1 and is generally shown at reference numeral 10. The system 10 comprises a plurality of media player devices 110 and a server computer 100. There is two-way communication link 120 that allows each media player device 110 to transmit information pertaining to the assets that are stored locally on each respective media player device 110 to the server computer 100. The communication links 120 may be one or a combination of wired and wireless (RF) communication networks, including the Internet. The server computer 100 synchronizes and compiles the information that is received from the respective media player devices 110. Further details of a system of the type shown in FIG. 1 are disclosed in the commonly assigned PCT application No. PCT/USOO/27564, filed October 5, 2000, the entirety of which is incorporated herein by reference.

The server computer 100 (or a group of server computers), which may be addressable via a standard URL on the World Wide Web, functions to allow for the storage, stream and download of media assets to a media player device 110. In addition, as described above the server computer 100 provides connections to other source sites, such as sources of streaming Internet radio providers. The server computer 100 allows for synchronization and replication of a user's licensed assets with each of the user's media player devices 110. The server computer 100 may be accessible directly from a media player device 110 and may provide a customizable interface or view to each user, if desired.

Some or all of the user's licensed assets are catalogued and stored by a master media library database in the remote storage 250 and are managed by a database server application executed by the server computer 100.

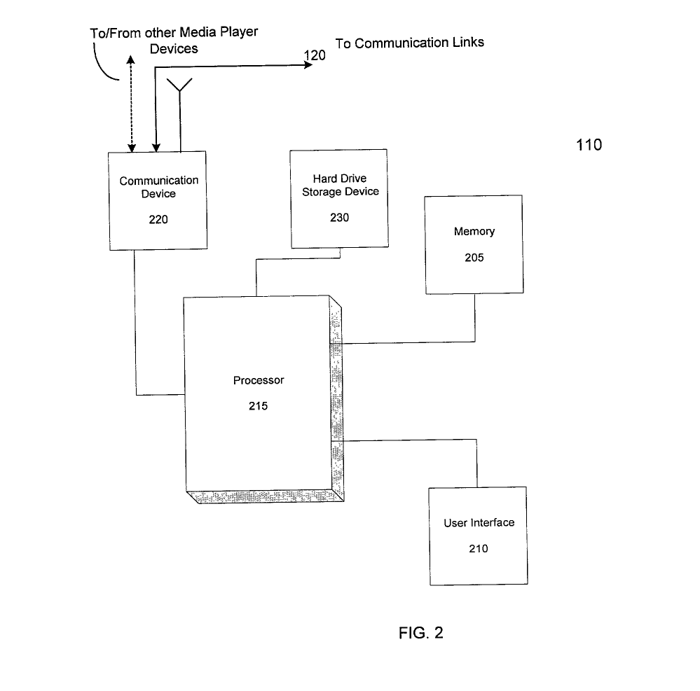

FIG. 2 illustrates an internal diagram of a media player device 110 that enables a user to play a digital media asset. The media player device 110 may be a home consumer device that connects to a television or other monitor as well as a home stereo (amplifier/tuner, etc.) which in turn is connected to speakers, a personal computer (PC) (laptop or desktop), a vehicle-based electronic device, a portable media player device, or a wireless electronic device. An example of still another type of media player device 110 is a cable set-top box.

Briefly, a media player device 110 comprises a processor 215 that executes a media playback software application program (or alternatively hardware) to enable a user to play or use a digital media asset, such as music, video, games, etc. The media player device 110 may comprise a memory 205, user interface 210, a hard drive storage device 230 and a communication device 220. The communication device 220 of the media player device may be a modem of any wired or wireless type, an EthernetTm card for connection to a local area network, etc. that performs two-way communication via the communication links 120 (FIG. 1). The memory 205 of the media player device 110 stores reference data pertaining to media assets stored on hard drive storage device 230 or on a remote storage 250 (FIG. 1). The communication device 220 further has the capability to electronically transmit data between media player devices and so may further include other communication capabilities, such as infrared (IR) transmission and reception, radio frequency (RF) communication, such as BluetoothTm communication capability, and other wired or wireless LAN connectivity. Another form of direct communication between media player devices may be achieved via a Universal Serial Bus (USB) or other hardware interface. A database client application may reside on the media player device 110 so as to manage access to and usage of media assets by the media player device.

Generally, the media player device 110 may roughly be the size of a CD/DVD player and provide for both audio and video output, though its size may vary with specific applications. The audio output may require an amplifier to drive speakers, or an amplifier may be included within the device. Video is directed to a television or monitor, or in some cases an integrated monitor. The media player device 110 receives its media assets via broadband demand download or stream, traditional phone line download or stream from the server computer 100 (FIG. 1) and/or other media partners. The media player device 110 is also able to download content and information from other Internet web sites through an embedded browser interface. Moreover, the media player device 110 can playback locally stored media assets such as CDs, DVDs, or other physical media as well as media assets stored on its local hard drive storage device 230.

An example of facilitating network technology for the media asset sharing between the media player devices is the JiniTm network technology developed by Sun Microsystems. JiniTm network technology provides simple mechanisms that enable devices to interface. Other technologies that might be utilized to implement media asset sharing are a Distributed Component Object Model (DCOM), Common Object Request Broker Architecture (CORBA), etc. Any of the aforementioned technologies may be utilized to implement an architecture that would allow the media player devices 110 to interact with the server computer 100 over the communications link 120.

A group of media player devices 110 will be described with reference to FIG. 1. A consumer may purchase multiple media player devices 110 that may be linked with the server computer 100, for example, the group comprised of media player devices MP1, MP2, MP3 and MP4. A group of media player devices 110 may be identified such that server computer 100 stores information designating or indicating that the media players in that group are authorized to know or share information about the media assets locally stored thereon and which players may obtain assets directly from each other. This relationship of a user's media player devices 100 would allow the user to inventory and access the media assets that reside on all of the user's media player devices 110 from any of the user's media player devices 110.

Once the server computer has identified a group of media player devices 110, the server computer 100 may utilize the two-way communication link 120 to transmit the media asset reference data of each member of an identified group of media player devices 110 to all of the members of that group. This transmission of data would enable an operator to access all the media assets and the information pertaining to them from any media player 110 that resides within the identified group of media player devices 110. The phantom lines in FIG. 1 are meant to represent the direct communication between media player devices within a group for the sharing of media assets stored thereon.

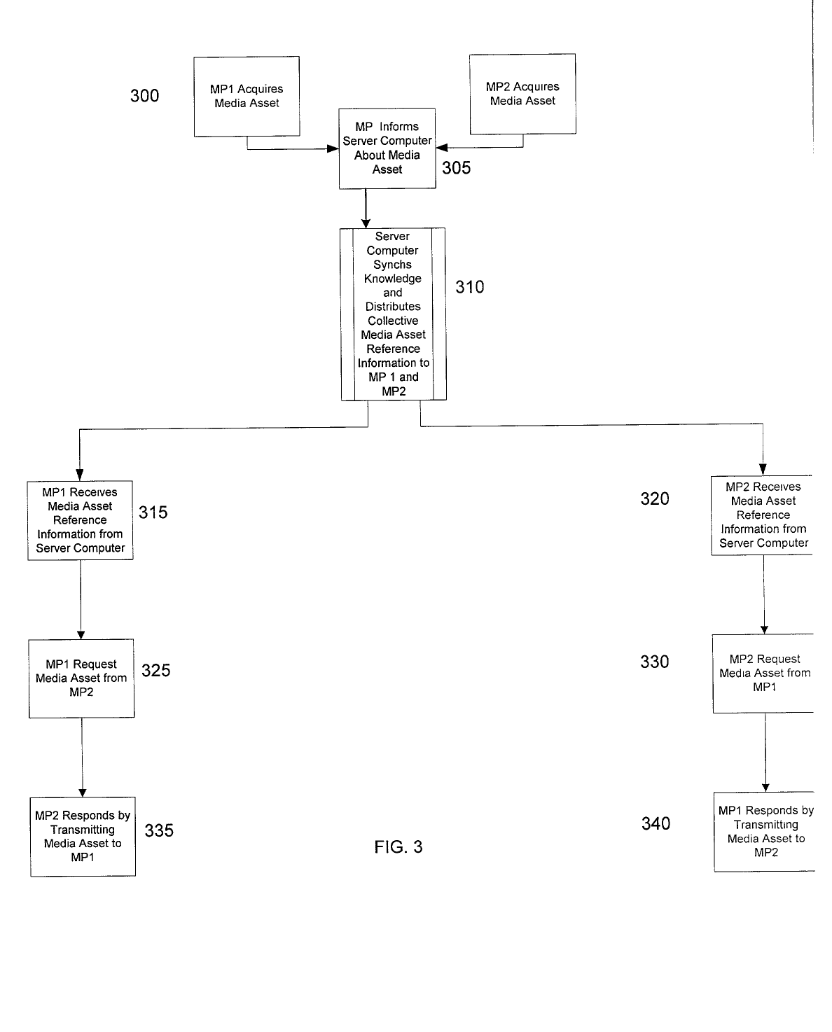

FIG. 3 is a flow diagram of a process according to the invention and illustrating an example wherein the server computer 100 is linked with two particular media player devices 110, hereinafter referred to as MP1 and MP2 (FIG. 1) as an example, that are part of a group of media player devices designated to share information with each other. In step 300, either or both of the media player devices MP1 and MP2 acquire media assets either through the server computer or by other means for storage locally therein. Periodically, as represented in step 305, each of the media player devices 110 contacts the server computer 100 and coordinates the reference (identification) information of media assets stored thereon with that of the master library database managed by the server computer 100. The server computer 100 in turn synchronizes this information with the master library database and distributes the media asset reference information associated with the locally stored media assets to MP1 and MP2 in step 310. The media player devices MP1 and MP2 receive and store the media asset reference information that has been transmitted from the server computer 100 in steps 315 and 320 so that the current knowledge about the media assets stored on MP1 and MP2 is loaded into the memories of MP2 and MP1 respectively. Thereafter, the media player devices MP1 and MP2 may freely request the transfer of a copy or the streaming of any media asset that is currently stored on the other media player devices, as shown in steps 325 and 330. In steps 335 and 340, MP1 and MP2 respond to the request from the other for media assets, and transmit (streams, transfers) the requested media asset to the requesting media player.

For example, MP1 possesses a particular media asset, such as the media asset A and MP2 possesses another particular media asset, such as the media asset B. MP1 will contact the server computer 100 and inform the server computer that media asset A resides within the MP1. The server computer 100 now has the knowledge that media asset A resides at MP1. When MP2 contacts the server computer 100 to update its media asset status information, the server computer 100 will accordingly respond by transmitting the media asset status (reference) information of MP1 to MP2. MP2 now has the knowledge that media asset A resides at MP1. The media asset status information can be displayed by MP2 to the media player operator, thereby informing the operator about media assets that are stored on MP1.

The media player device operator may choose to play media asset A from a list that is presented on the display of MP2. MP2 knows that media asset A does not reside locally on the media player device but rather is stored on MP1. Through the communication devices on MP1 and MP2 respectively, MP2 may now directly contact MP1 in order to gain access to media asset A. MP2 will accordingly transmit a request to MP1 that MP1 transmit (e.g., transfer or stream) the media asset A to MP2, after which the operator of MP2 is presented with the media asset at MP2 for use.

As will be recognized by those skilled in the art, the innovative concepts describe in the present application can be modified and varied over a wide range of applications. Accordingly, the scope of patented subject matter should not be limited to any of the specific exemplary teachings describe herein.

What is claimed is:

1. A system for the distribution of media assets comprising:
a server computer executing a database server application that manages access to a database of media assets that can be stored on one or more media player devices; and
at least first and second media player devices that individually communicate with the server computer to update the database with the identity of the media assets that are respectively stored thereon; and
the server computer further stores information identifying media assets stored on the at least first and second media player devices that are designated to share information about the media assets locally stored therein, whereby the first media player device is informed about the identity of media assets that are stored on the second media player device.

2. The system of claim 1, wherein the database server application of the server computer synchronizes with a database client application within each media player device in order to obtain information pertaining to media assets stored on the media player devices.

3. The system of claim 1, wherein the second media player device transmits a media asset stored thereon to the first media player device for storage and use thereon.

4. The system of claim 3, wherein the first media player device transmits to the second media player device a request for access to a media asset stored on the second media player device, wherein the second media player in response to the request transmits the media asset(s) to the first media player.

5. The system of claim 3, wherein the media player devices communicate with each other via a wired communication link and the media player devices communicate with the server computer via a wired communication link.

6. The system of claim 3, wherein the media player devices communicate with each other via an infrared communication link.

7. The system of claim 3, wherein the media player devices communicate with each other via a wireless communication link and the media player devices communicate with the server computer via a wireless communication link.

8. The system of claim 3, wherein the media player devices communicate with each other via a RF communication link and the media player devices communicate with the server computer via a RF communication link.

9. A method for the distribution of media assets comprising steps of:
storing a plurality of media assets and identifiers associated with the media assets on a central computer;
storing a plurality of media assets and identifiers associated with said media assets on each of at least first and second media player devices;
synchronizing the identity of those media assets stored on the first and second media player devices respectively with the central computer; and
transmitting from the central computer to each of the first and second media player devices information about the media assets that is stored on the first and second media player devices.

10. The method of claim 9, further comprising the step of transmitting a media asset from the first media player device to the second media player device.

11. The method of claim 10, further comprising steps of: a first media player device requesting the second media player device for access to a media asset stored on the second media player device; and transmitting in response to the request the media asset to the first media player from the second media player device.

12. The method of claim 10, wherein the media player devices communicate with each other via a wired communication link and the media player devices communicate with the central computer via a wired communication link.

13. The method of claim 10, wherein the media player devices communicate with each other via a wireless communication link and the media player devices communicate with the central computer via a wireless communication link.

14. The method of claim 10, wherein the media player devices communicate with each other via an infrared communication link.

15. The method of claim 10, wherein the media player devices communicate with each other via a RF communication link and the media player devices communicate with the central computer via a RF communication link.

16. A system for the distribution of media assets comprising:
a server computer executing a database server application that manages access to a master database of media assets that can be stored and used by one or more media player devices; at least first and second media player devices each comprising a database client application that manages access and usage of media assets, wherein the media player devices individually communicate with the database server application at the server computer to update the master database with the identity of the media assets that are stored thereon;
the server computer further storing information indicating that the at least first and second media player devices are designated to share information about the media assets locally stored thereon and such that the first and second media player devices receive such information when communicating with the server computer;
wherein the second media player device receives a request for a particular media asset stored thereon from the first media player device and in response transmits the particular media asset stored to the first media player device for storage and use thereon.
